(19) United States
(12) Patent Application Publication
(10) Pub. No.: US 2006/0236475 A1
(43) Pub. Date: Oct. 26, 2006

(54) Mehtod for cleaning a component and appropriate cleaning device

(76) Inventors: Uwe Habisreitinger, Lossburg (DE); Bernhard Nordmann, Boeblingen (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/520,232

(22) PCT Filed: Jul. 2, 2003
(86) PCT No.: PCT/EP03/07047

§ 371 Date: Jul. 11, 2005

(30) Foreign Application Priority Data
Jul. 4, 2002 (DE) 102 30 021.6

(51) Int. Cl. B60S 3/04

(52) U.S. Cl. 15/53.1; 15/97.3; 15/DIG. 2

(57) ABSTRACT

The invention relates to a method for cleaning at least one surface (12) of a component (10), using a cleaning device (14), wherein the surface (12) of the component is cleaned by a cleaning head (18) movable by a positioning device (16), said cleaning head (18) exerting a contact pressure on the component (10). The positioning device (16) has a rough positioning system (20) and a fine positioning system (22), wherein the cleaning head (18) is moved in a force controlled manner by the rine positioning system (22) in at least one direction of movement (24, 26, 28, 30, 32, 34). The invention also relates to a corresponding cleaning device for implementing the inventive method.

### BACKGROUND OF THE INVENTION

1. Field of the Invention

The invention relates to a method for cleaning at least one surface of a component using a cleaning device, the surface of the component being cleaned by means of a cleaning head which can be moved by a positioning device, while forming a contact pressure of the cleaning head on the component, according to the precharacterizing clause of claim 1. Furthermore, the invention relates to a cleaning device which serves for cleaning at least one surface of a component and has a cleaning head which can be moved by means of a positioning device, corresponding to the precharacterizing clause of claim 9.

2. Related Art of the Invention

Methods and cleaning devices of the type stated above are known. DE 42 21 026 A1 discloses a cleaning robot for a printing machine. EP 0 642 318 B1 discloses a device for cleaning windows which has for this purpose a robotic control device with a sensor function for object geometry sensing. These known cleaning systems are disadvantageous, since an undesirably severe collision with the component to be cleaned can only be avoided with relatively great expenditure. In this respect, it is possible in principle to determine precisely the complete geometry of the respective component and transfer it in the form of data to an associated control unit. Furthermore, damage to the component by the cleaning device during the cleaning operation can be virtually ruled out by suitable sensor means, but with correspondingly great expenditure in terms of apparatus and control technology.

### SUMMARY OF THE INVENTION

It is an object of the invention to propose a method and a suitable cleaning device of the type stated at the beginning which allow automated cleaning of a component which can be controlled relatively easily and can be implemented correctly.

To achieve the object, a method with the features of claim 1 is proposed. The method according to the invention is distinguished by the fact that the positioning device has a rough positioning system and a fine positioning system, the cleaning head being moved in a force-controlled manner by means of the fine positioning system in at least one direction of movement.

On the basis of the force-controlled movement of the cleaning head, it is possible to limit the contact pressure by means of the fine positioning system with regard to its maximum value and thereby to predetermine it in a defined form. As a result, on the one hand the occurrence of unexpectedly great pressing or colliding forces between the cleaning head and the component is avoided and on the other hand it is made possible for correct cleaning of the component to be implemented even without sensors and/or without sensing of the complete geometry of the component, that is to say merely with knowledge of the general or approximate contour of the component, since the cleaning device is adapted to the component tolerance that is to be expected. Consequently, even inaccuracies with regard to a positioning of the respective component do not have to be sensed, in particular before the beginning of a cleaning operation, since they are compensated up to predeterminable tolerances on the basis of an adaptive behavior of the fine positioning system similar to a spring element as a result of the force-controlled movement. Consequently, the cleaning head can be moved along at least one axis of movement by means of the fine positioning system within a predeterminable and consequently limited tolerance window. In this way, the movement of the cleaning head in contiguous contact with the component can take place by means of the fine positioning system alone, utilizing the advantages stated above, or by means of simultaneous actuation of the rough positioning system and the fine positioning system.

The contact pressure is advantageously variable, and in particular can be set infinitely variably, to optimize cleaning. As a result, the contact pressure can be predetermined in dependence on an active contact surface of the cleaning head of varying size and/or in dependence on a parameter of the component. In this way it is possible to produce a component-adapted and cleaning-optimizing contact pressure value by means of the cleaning device, it also being possible, if appropriate, for contact pressure values of different magnitudes to be chosen during a cleaning operation, in dependence on the respective direction of movement.

The changing of the contact pressure on the fine positioning system may take place in an automated or manual manner before and/or during the cleaning operation. Automated changing of the contact pressure is possible for example by means of a preprogrammed control device. The cleaning device is consequently characterized by particularly high flexibility with respect to the main parameter “cleaning force”, while operationally reliable cleaning of the component is at the same time ensured along with relatively low control expenditure. In this case, the cleaning head can be moved manually by means of a manipulator as the positioning device or else in an automated manner by means of a robot as the positioning device. A manipulator (teleoperator controlled by an operator) allows particularly easy-to-handle and—in comparison with a wiping movement carried out directly, that is to say purely manually—ergonomically favorable cleaning of the component.

Also proposed for achieving the object is a cleaning device with the features of claim 9. The cleaning device according to the invention is distinguished by the fact that the positioning device has a rough positioning system and a fine positioning system, the movement of the cleaning head being force-controlled by means of the fine positioning system at least in one direction of movement. By means of a cleaning device of this type, the advantages previously mentioned with respect to the method can be achieved. Furthermore, a force-controlling fine positioning system can be realized in a relatively simple form of construction. This applies in particular if the fine positioning system is formed as a functional unit with limited maximum force. For this purpose, the fine positioning system may have for at least one, and preferably all, of the directions of movement of the cleaning head that are relevant to component collision a respectively assigned fine positioning element for predetermining the contact pressure specific to the direction of movement. The fine positioning element preferably includes a telescopic adjusting mechanism, so that the cleaning head can be displaced by means of the fine positioning system along at least one axis of movement within a predetermined tolerance window. In this case, the tolerance window is defined by the maximum adjusting displacement of the fine positioning system and/or by the geometry of the cleaning head. The fine positioning element can be set in particular infinitely variably with regard to its maximum adjusting force, while forming the contact pressure, for example by means of a pneumatic or hydraulic actuating unit. Actuating units of this type allow relatively simple and rapid setting in terms of control technology of one or, if appropriate, more than one different contact pressure.

The cleaning head is advantageously adjustable in its position by means of the fine positioning system along three axes of movement which are substantially orthogonal to one another. In addition, the cleaning head can preferably be moved rotatably about at least one axis of rotation. In this case, the rotational movement may take place for example by means of the rough positioning system, in particular in the form of a robot arm. Such a complexly movable cleaning head allows automated and sufficiently accurately reproducible cleaning even of geometrically differently shaped components, if appropriate with suitable wiping movements. If there are possibilities of collision with the component on account of a rotational wiping movement of the cleaning head, this movement may also be produced by means of a correspondingly force-controlling fine positioning element, so that even in a rotational wiping movement a maximum upper limit of the contact pressure or the collision force cannot be exceeded. The cleaning head may consequently have for at least one, and preferably all, of the directions of movement that are relevant to component contact a corresponding cleaning stop surface, which is assigned a respective fine positioning element.

According to a preferred embodiment, the cleaning head is exchangeably fastened to the fine positioning system, for example by means of a bayonet fastening system. As a result, a rapid cleaning head change, in particular in the case of a soiled cleaning head, and more flexible component cleaning—with respect to the use of differently formed cleaning heads—are made possible.

The cleaning device may be formed as a manipulator device or, for automated cleaning, as a robot device. In the case of a robot device, the rough positioning device is preferably provided with a movable robot arm, fastened to the free end of which is the fine positioning system, which carries the cleaning head. For at least partially automated positioning of the cleaning head and cleaning of the component, the cleaning device is preferably provided with a programmable open-loop and/or closed-loop control device.

The cleaning head advantageously has a three-dimensionally extending cleaning surface. In this respect, it may include at least one stop shoulder, which can be moved with its cleaning stop surface frontally against a component edge, while forming the contact pressure. The cleaning surface is formed particularly advantageously in a substantially U-shaped or L-shaped manner. Furthermore, the cleaning surface may have at least one undercut, which can be brought into contiguous contact with a component surface. This allows component surfaces lying on the front side and component surfaces lying on the rear side, such as for example a bent-around region of a vehicle door, to be cleaned by means of the cleaning head in an operationally reliable and rapid manner in a single wiping operation.

The cleaning head is preferably provided on its component contact side with at least one exchangeable cleaning element, it being possible for the cleaning element to be a sponge and/or a brush element and/or a cloth, and in particular a microfiber cloth. The determination of a suitable cleaning element may be based on the respective cleaning task to be performed, so that the cleaning device can be used flexibly for solving a wide variety of cleaning problems. Attaching the cleaning element to the cleaning head can in this case take place in an automated or manual manner.

The cleaning device advantageously has a store for the intermediate storage of at least one cleaning head and/or at least one cleaning element. Furthermore, it may have a cleaning-head and/or cleaning-element handling device. A handling device of this type may serve for example for cleaning the cleaning head and/or the cleaning element and, if appropriate, for additionally wetting it with a cleaning fluid prior to carrying out wet cleaning of a component.

The component to be cleaned may be, for example, a component of a vehicle body with at least one surface to be cleaned in a defined manner with regard to the contact pressure to be applied. For example, in outer regions of the frame, that is in regions of so-called “A, B or C pillars”, vehicle doors to be provided with coating films and previously coated vehicle doors can be cleaned by means of the cleaning device in an operationally favorable manner prior to the coating film application. Furthermore, seal seating surfaces of components of a body can be effectively cleaned by means of the cleaning device before applying a corresponding sealing tape, or else adhesive surfaces can be cleaned in preparation, the flexible way in which the cleaning device, and in particular the cleaning head, can be configured meaning that there are virtually no restrictions with respect to the component geometry that can be cleaned. A cleaning device formed as a robot can be advantageously combined with further processing or assembly devices of a production plant or, after attaching a suitable processing head, can also be used for carrying out some other processing step other than cleaning.

### BRIEF DESCRIPTION OF THE DRAWINGS

Further advantages of the invention emerge from the description.

The invention is explained in more detail on the basis of a preferred exemplary embodiment with reference to a schematic drawing, in which:

FIG. 1 shows a schematic perspective representation of a cleaning device according to the invention and of a component to be cleaned;

FIG. 2 shows a schematic perspective representation of a detail of the cleaning device of FIG. 1 on an enlarged scale;

FIG. 3 shows a schematic perspective representation of a cleaning head, partially provided with a cleaning element, of the cleaning device of FIG. 1 on an enlarged scale;

FIG. 4 shows a schematic perspective representation of the cleaning head, provided with the cleaning element, of FIG. 3 in abutting contact with the component and

FIG. 5 shows a further perspective representation of the cleaning head provided with the cleaning element in abutting contact with the component.

### DETAILED DESCRIPTION OF THE INVENTION

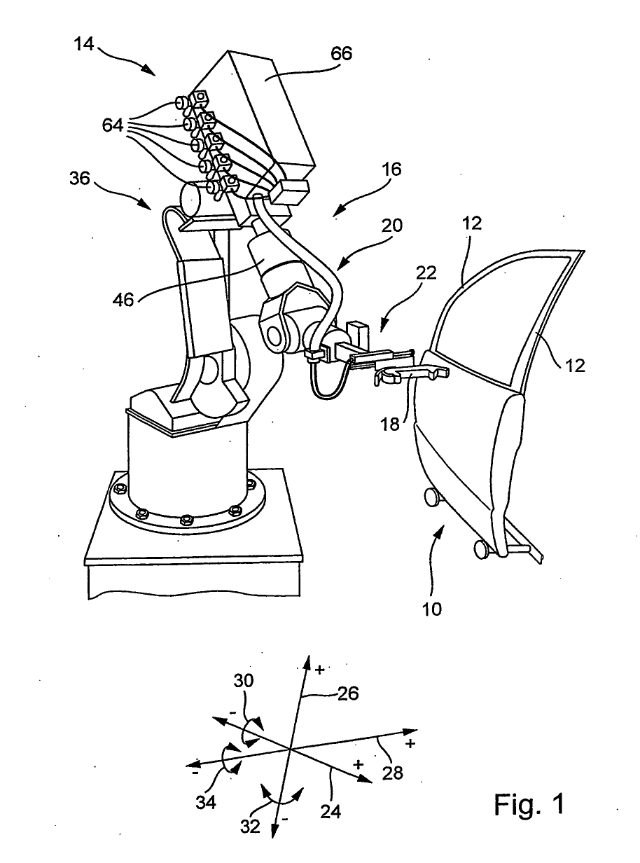

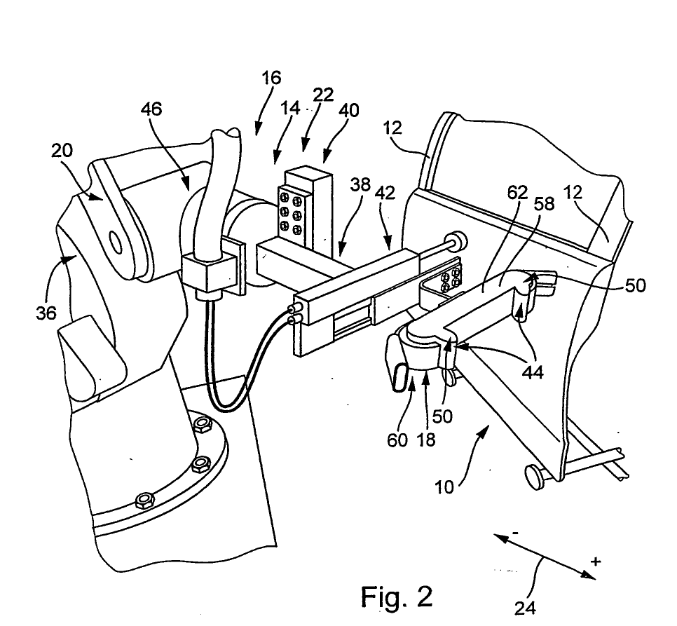

FIGS. 1 and 2 show a cleaning device 14 for cleaning a surface 12 of a component 10 in a schematic representation. In the present exemplary embodiment, the component 10 is a component of a vehicle body in the form of a vehicle door, the surfaces 12 of which that are to be cleaned being formed by the window frame. In particular, the outer surface on the front side of the so-called “A and B pillars” or “B and C pillars” of a vehicle door as well as the adjoining bent-around regions lying on the rear side of the vehicle door are to be cleaned or freed from dust by means of the cleaning device 14. The operation of cleaning these regions of a vehicle door may for example represent component preparation for subsequent coating film application. For cleaning the component, the cleaning device 14 has a cleaning head 18 which can be moved by means of a positioning device 16 and can be brought into cleaning contact with the component 10, or with its surfaces 12 to be cleaned, while forming a contact pressure which generally influences the cleaning action.

The positioning device 16, which is part of a robot 36 or an industrial robot, includes a rough positioning system 20 and a fine positioning system 22. The rough positioning system 20 is formed as a robot arm 46 which can be moved in an automated manner, has six axes which can be moved in an automated manner and fastened to the free end of which is the fine positioning system 22, which carries the cleaning head 18. The cleaning head 18 is exchangeably fastened to the fine positioning system 22, for example by means of a bayonet fastening system (not represented in the figures). The rough positioning system 20 serves for the rough spatial positioning of the cleaning head 18 with respect to the component 10, the cleaning head 18 generally not yet being brought into contiguous contact with the component 10. To establish desired contiguous contact for the cleaning operation, a movement of the cleaning head 18 following the rough positioning of the robot arm 46 can then take place by means of the fine positioning system 22 in relation to the robot arm 46. This movement in the course of fine positioning of the cleaning head 18 takes place in a force-controlled manner in at least one possible direction of movement 24, 26, 28, 30, 32, 34. In the case of the present exemplary embodiment, movements of the cleaning head 18 along the axes of movement in the “±” direction according to the double-headed arrows 24, 26, 28 are force-controlled by means of the fine positioning system 22, while the movements about the axes of rotation according to the double-headed arrows 30, 32, 34 are exclusively displacement-controlled by means of the rough positioning system (robot arm 46). The three axes of movement 24, 26, 28 are substantially orthogonal to one another and are perspectively represented in FIG. 1 with respect to the shown operating position of the robot arm 46. The fine positioning system 22 is formed as a functional unit with limited maximum force, it having for this purpose, for the directions of movement 24, 26, 28 of the cleaning head 18 that are relevant to component collision, a respectively assigned fine positioning element 38, 40, 42, so that the contact pressure respectively occurring between the cleaning head 18 and the component surface 12 during the cleaning operation is limited specifically with respect to the direction of movement.

The fine positioning elements 38, 40, 42 in each case include a telescopic adjusting mechanism with a respectively predetermined adjusting displacement. The cleaning head 18 is displaceable by means of the fine positioning system 22 along the axes of movement 24, 26, 28 within a defined tolerance window. The tolerance window is in this case predetermined by an adjusting displacement of the fine positioning system 22 respectively adapted to the cleaning task and is limited with regard to its maximum extent. If appropriate, the geometry of the cleaning head 18 may also represent an additional restriction on the adjusting displacement of the cleaning head 18, that is to say for the case in which the cleaning head 18 collides into the component 10 with a stop surface, described in more detail further below, while forming the contact pressure, before the associated telescopic adjusting mechanism has been extended to a maximum possible length of adjusting displacement. The fine positioning elements 38, 40, 42 can be variably set with regard to their maximum adjusting force, while forming a respectively desired contact pressure. In this respect, the fine positioning elements 38, 40, 42 have a pneumatic or hydraulic actuating unit.

The fine positioning elements 38, 40, 42, in each case having a telescopic adjusting mechanism, are respectively formed as a cylinder-piston system, a piston movement preferably taking place according to the present exemplary embodiment by means of compressed air. The open-loop or closed-loop control of the air pressure may in this case take place infinitely variably by means of an associated proportional valve with respect to the respective direction of movement. The cleaning device 14 corresponding to FIG. 1 includes five proportional valves 64, which can be actuated by means of an open-loop or closed-loop control system 66 and make possible a force-controlled movement of the cleaning head 18 in the “±” directions 26, 27 and in the “+” direction 24. To perform the cleaning task represented in FIGS. 1 to 5, a force-controlled movement in the “−” direction 24 is not required (see in particular FIG. 2), but can likewise be realized in a corresponding way.

The cleaning head 18 has for at least one direction of movement that is relevant to component contact, in the present exemplary embodiment for the direction of movement 28, two cleaning stop surfaces 44 which are spaced apart from and opposite each other, the fine positioning element 42 being functionally assigned to these cleaning stop surfaces 44. Furthermore, the cleaning device 14 is provided with a programmable open-loop and or closed-loop control device for the at least partially automated positioning of the cleaning head 18 and for the corresponding implementation of the actual cleaning operation on the component 10.

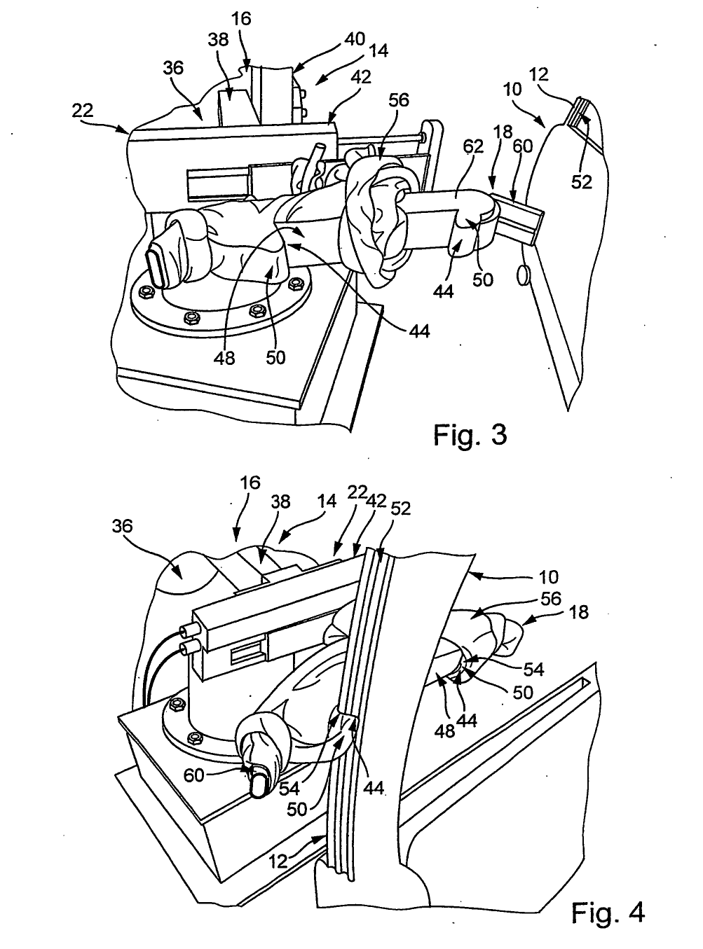

The cleaning head 18 includes a carrier structure 60, fastened to which is a foam element 62, which carries an exchangeable cleaning element 56 in the form of a microfiber cloth. In the present exemplary embodiment according to FIGS. 3 to 5, the cleaning head 18 is provided with a three-dimensionally extending cleaning surface 48. In this case, it has two stop shoulders 50, which are spaced apart from and opposite each other and can be moved with their respective cleaning stop surface 44 frontally against a corresponding component edge 52, while forming the contact pressure. For this purpose, the cleaning surface 48 is formed in a substantially U-shaped manner and includes for each stop shoulder 50 an undercut 54, which can be brought into contiguous contact with a component surface 12. Depending on the cleaning task, the cleaning head 18 may be provided, if appropriate, with an additional suction and/or blowing system (not represented in the figures), for example with compressed air as the operating medium.

The cleaning device 14 may have a store (not represented in the figures), formed as a changing magazine, for the intermediate storage of at least one cleaning head 18 and/or a cleaning element 56. Furthermore, a cleaning-head and or cleaning-element handling device may be provided, so that both the cleaning head preparation and the cleaning operation itself can be implemented in an automated manner.

The movement of the cleaning head 18 in contiguous contact with the component 10 may take place by means of the fine positioning system 22 on its own or, if need be, also by means of simultaneous actuation of the rough positioning system 20 and the fine positioning system 22. To optimize cleaning, the contact pressure can be variably set. In this case, the contact pressure can be predetermined in dependence on an active contact surface of the cleaning head 18 of varying size and/or in dependence on a parameter of the component. “Contact surface” is understood here as meaning that part of the cleaning surface of the cleaning head 18 which is in contiguous contact with the component 10 to be cleaned, while forming the contact pressure. One possible parameter of the component which should be taken into account for determining a desired maximum contact pressure value is the inherent stability or the compliance of the component 10, in particular in the region of the surface 12 that is respectively to be cleaned, since the cleaning result can also be influenced by this. Consequently, it may be entirely appropriate for contact pressure values of different magnitudes to be predetermined during a cleaning operation, including on the basis of possibly differing degrees of soiling of the component surfaces 12, it being possible for the changing of the contact pressure on the fine positioning system 22 to take place in an automated or manual manner before and/or during the cleaning operation.

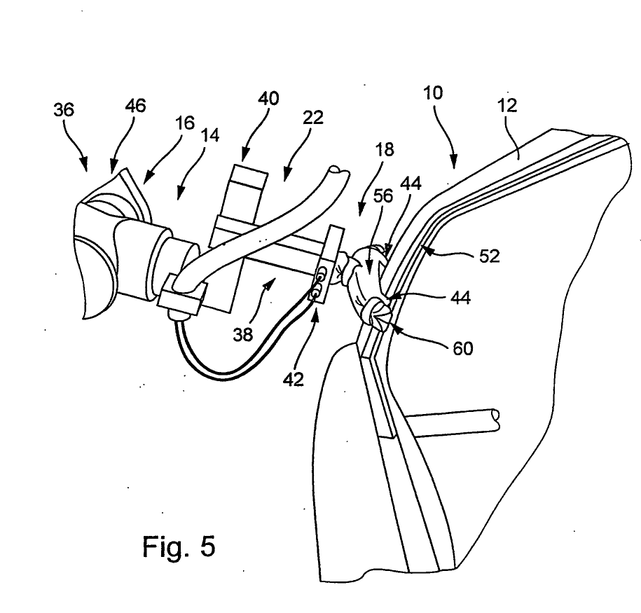

The operating mode of the cleaning device 14 may, for example, be such that the robot arm 46 carrying the fine positioning system 22 at its free end is loaded with a suitable cleaning head 18 in an automated manner in a cleaning head changing station. The robot arm 46, acting as a rough positioning system 20, then moves the cleaning head 18 into a starting position, from which the cleaning head 18 can be moved in a force-controlled manner by means of the fine positioning element 38 in the direction of movement 24 and can consequently be brought into contiguous contact with the component 10, while forming the contact pressure, the desired contact pressure value having been entered in advance in the open-loop or closed-loop control system 66. In this case, the fine positioning element 38 is preferably not extended by the maximum possible length of adjusting displacement, so that, if appropriate, automatic readjustment of the cleaning head 18 in the direction of movement 24 by the remaining residual length of adjusting displacement is possible, while ensuring permanent contiguous contact with the component 10. The fine positioning element 38 consequently has the effect of a spring element, but without a spring characteristic, since a virtually constant contact pressure is always produced, independently of the adjusting displacement. Once the contiguous contact has been established between the cleaning head 18 and the component 10, the cleaning head 18 is moved in a force-controlled manner by means of the fine positioning element 42 in the way shown in FIG. 4 until it butts with a cleaning stop surface 44 of the corresponding stop shoulder 50 against a component edge 52 to be cleaned (bent-around region of the B pillar), while forming the contact pressure predetermined for the fine positioning element 42. The cleaning head 18 is subsequently moved along the B pillar by means of the fine positioning element 42 and/or by means of the robot arm 46 (see in particular FIG. 5), both the front-side contact surface 12 and the component edge 52 (bent-around region) being cleaned simultaneously. If appropriate, additional handling steps may also be provided for the cleaning head 18 during the cleaning operation. What is decisive for this cleaning operation is that all the contact pressures occurring are produced by means of the respectively associated fine positioning element and are consequently predetermined in terms of their magnitude.

In the present exemplary embodiment, the cleaning head 18 can be moved by means of the fine positioning system 22 within a tolerance window of about ±25 mm for each direction of movement 24, 26, 28. Even if the cleaning head is moved along a predetermined path, adapted to the component contour, by means of the rough positioning system 20, it is possible on account of the fine positioning system 22 to dispense with relatively complex sensor equipment for the suitable positioning of the cleaning head 18 on the component 10 while forming a contact pressure.

The further structural design and operating mode of the cleaning device are known per se, so there is no need for a more detailed description.

1. A method for cleaning at least one surface (12) of a component (10) using a cleaning device (14), the surface (12) of the component being cleaned by means of a cleaning head (18) which can be moved by a positioning device (16), while forming a contact pressure of the cleaning head (18) on the component (10), the positioning device (16) having a rough positioning system (20) and a fine positioning system (22) and the cleaning head (18) being moved in a force-controlled manner by means of the fine positioning system (22) in at least one direction of movement (24, 26, 28, 30, 32, 34), characterized in that the cleaning head (18) has a three-dimensionally extending cleaning surface (48) and at least one stop shoulder (50), which can be moved with its cleaning stop surface (44) frontally against a component edge (52), while forming the contact pressure, the cleaning head (18) being moved along at least one axis of movement (24, 26, 28) by means of the fine positioning system (22) within a predeterminable tolerance window.

2. The method as claimed in claim 1, characterized in that the contact pressure by means of the fine positioning system (22) is limited with regard to its maximum value.

3. The method as claimed in one of the preceding claims, characterized in that the movement of the cleaning head (18) in contiguous contact with the component (10) takes place by means of the fine positioning system (22) alone or by means of simultaneous actuation of the rough positioning system (20) and the fine positioning system (22).

4. The method as claimed in one of the preceding claims, characterized in that, to optimize cleaning, the contact pressure can be variably set.

5. The method as claimed in one of the preceding claims, characterized in that the contact pressure is predetermined in dependence on an active contact surface of the cleaning head (18) of varying size and/or in dependence on a parameter of the component.

6. The method as claimed in one of the preceding claims, characterized in that the changing of the contact pressure on the fine positioning system (22) take places in an automated or manual manner before and/or during the cleaning operation.

7. The method as claimed in one of the preceding claims, characterized in that the cleaning head (18) is moved manually by means of a manipulator as the positioning device (16) or in an automated manner by means of a robot (36) as the positioning device (16).

8. A cleaning device, in particular for implementing the method as claimed in one of the preceding claims, the cleaning device (14) serving for cleaning at least one surface (12) of a component (10) and having a cleaning head (18) which can be moved by means of a positioning device (16), the positioning device (16) having a rough positioning system (20) and a fine positioning system (22) and the movement of the cleaning head (18) being force-controlled by means of the fine positioning system (22) at least in one direction of movement (24, 26, 28, 30, 32, 34), characterized in that the cleaning head (18) has a three-dimensionally extending cleaning surface (48) and has at least one stop shoulder (50), which can be moved with its cleaning stop surface (44) frontally against a component edge (52), while forming the contact pressure, the cleaning head (18) being displaceable by means of the fine positioning system (22) along at least one axis of movement (24, 26, 28) within a predeterminable tolerance window.

9. The cleaning device as claimed in claim 8, characterized in that the fine positioning system (22) is formed as a functional unit with limited maximum force.

10. The cleaning device as claimed in claim 8 or 9, characterized in that the tolerance window is defined by the maximum adjusting displacement of the fine positioning system (22) and/or by the geometry of the cleaning head (18).

11. The cleaning device as claimed in one of claims 8 to 10, characterized in that the fine positioning system (22) has for a number of directions of movement (24, 26, 28) of the cleaning head (18) that are relevant to component collision a respectively assigned fine positioning element (38, 40, 42) for predetermining the contact pressure specific to the direction of movement.

12. The cleaning device as claimed in claim 11, characterized in that the fine positioning element (38, 40, 42) has a telescopic adjusting mechanism.

13. The cleaning device as claimed in claim 11 or 12, characterized in that the fine positioning element (38, 40, 42) can be variably set with regard to its maximum adjusting force, while forming the contact pressure.

14. The cleaning device as claimed in one of claims 11 to 13, characterized in that the fine positioning element (38, 40, 42) has a pneumatic or hydraulic actuating unit.

15. The cleaning device as claimed in one of claims 8 to 14, characterized in that the cleaning head (18) is adjustable in its position by means of the fine positioning system (22) along three axes of movement (24, 26, 28) which are substantially orthogonal to one another.

16. The cleaning device as claimed in one of claims 8 to 15, characterized in that the cleaning head (18) can be moved rotatably about at least one axis of rotation (30, 32, 34).

17. The cleaning device as claimed in one of claims 11 to 16, characterized in that the cleaning head (18) has for at least one direction of movement (24, 26, 28) that is relevant to component contact a cleaning stop surface (44) with an associated fine positioning element (42).

18. The cleaning device as claimed in one of claims 8 to 17, characterized in that the cleaning head (18) is exchangeably fastened to the fine positioning system (22).

19. The cleaning device as claimed in one of claims 8 to 18, characterized in that it is formed as a manipulator device or as a robot (36).

20. The cleaning device as claimed in one of claims 8 to 19, characterized in that the rough positioning device (20) has a movable robot arm (46), fastened to the free end of which is the fine positioning system (22), which carries the cleaning head (18).

21. The cleaning device as claimed in claim 19 or 20, characterized in that it has a programmable open-loop and/or closed-loop control device for the at least partially automated positioning of the cleaning head (18) and cleaning of the component (10).

22. The cleaning device as claimed in one of claims 8 to 21, characterized in that the cleaning surface (48) is formed in a substantially U-shaped or L-shaped manner.

23. The cleaning device as claimed in one of claims 8 to 22, characterized in that the cleaning surface (48) has at least one undercut (54), which can be brought into contiguous contact with a component surface (12).

24. The cleaning device as claimed in one of claims 8 to 23, characterized in that the cleaning head (18) is provided on its component contact side with at least one exchangeable cleaning element (56).

25. The cleaning device as claimed in claim 24, characterized in that the cleaning element (56) is a sponge and/or a brush element and/or a cloth, and in particular a microfiber cloth.

26. The cleaning device as claimed in one of claims 8 to 25, characterized in that it has a store for the intermediate storage of at least one cleaning head (18) and/or at least one cleaning element (56).

27. The cleaning device as claimed in one of claims 8 to 26, characterized in that it has a cleaning-head and/or cleaning-element handling device.

28. The cleaning device as claimed in one of claims 8 to 27, characterized in that the component (10) is a component of a vehicle body with at least one surface (12) to be cleaned in a defined manner with regard to the contact pressure to be applied.
